(19) United States
(12) Patent Application Publication
(10) Pub. No.: US 2017/0104351 A1
(43) Pub. Date: Apr. 13, 2017

(54) ELECTRONIC SYSTEM FOR MANAGING AN ELECTRIC BATTERY

(71) Applicant: Commissariat à l'Energie Atomique et aux Energies Alternatives, Paris (FR)

(72) Inventors: Daniel CHATROUX, Teche (FR); Laurent GARNIER, Marennes (FR); Sylvain MERCIER, Saint-Egreve (FR)

(21) Appl. No.: 15/290,099

(22) Filed: Oct. 11, 2016

(30) Foreign Application Priority Data
Oct. 12, 2015 (FR) 1559668

(51) Int. Cl. H02J 7/00

(52) U.S. Cl. CPC H02J 7/0016; H02J 7/0021

(57) ABSTRACT

An assembly including a battery and a management system, wherein: the battery includes at least three stages in series between a negative terminal and a positive terminal of the battery; and the management system includes: at least two first voltage sensors each having first and second measurement nodes connected by at least two consecutive stages of the battery, said first sensors being arranged so that each stage has its positive terminal connected to one of the first sensors, and does not have its negative terminal connected to the same first sensor; and at least one second voltage sensor having first and second measurement nodes respectively coupled to the positive terminal and to the negative terminal of a same stage of the battery.

### CROSS-REFERENCE TO RELATED APPLICATION

This application claims the priority benefit of French patent application number 15/59668, the content of which is hereby incorporated by reference in its entirety to the maximum extent allowable by law.

### BACKGROUND

The present disclosure generally relates to the field of electric batteries, and more specifically aims at an assembly comprising a battery of electrical energy storage cells and an electronic system for managing the battery.

### DISCUSSION OF THE RELATED ART

An electric battery is a group of a plurality of identical or similar rechargeable electrical energy storage cells (cells, accumulators, supercapacitors, etc.) coupled in series and/or in parallel between two respectively positive and negative voltage supply terminals. During battery discharge phases, a current flows from the positive terminal to the negative terminal of the battery, through a load to be powered. During battery recharge phases, a charger applies a recharge current flowing from the negative terminal to the positive terminal of the battery (through the charger). A battery is generally associated with an electronic management system capable of implementing battery recharge control, discharge control, and/or cell balancing operations. There is a need for an assembly comprising an electric battery and an electronic battery management system, such an assembly at least partly overcoming certain disadvantages of existing assemblies.

### SUMMARY

For this purpose, an embodiment provides an assembly comprising a battery of electrical energy storage cells and a management system, wherein: the battery comprises at least three stages in series between a negative terminal and a positive terminal of the battery, each stage comprising a single cell or a plurality of cells in series and/or in parallel between a negative terminal and a positive terminal of the stage; and the management system comprises: at least two first voltage sensors each having first and second measurement nodes coupled by at least two consecutive stages of the battery, said first sensors being arranged so that each stage has its positive terminal connected to one of the first sensors, and does not have its negative terminal connected to the same first sensor; and at least one second voltage sensor having first and second measurement respectively connected to the positive terminal and to the negative terminal of a same stage of the battery.

According to an embodiment, the management system further comprises a processing circuit capable of receiving the values of the voltages measured by said voltage sensors, and of deducing therefrom, by subtraction operations, the value of the voltage across each of the stages.

According to an embodiment, each of the first sensors has its measurement nodes coupled by only two consecutive stages of the battery.

According to an embodiment, the assembly comprises a single second voltage sensor.

According to an embodiment, the second voltage sensor is connected across a stage located at one end of the series association of stages of the battery.

According to an embodiment, the assembly only comprises two second voltage sensors.

According to an embodiment, the second voltage sensors are respectively connected across the first stage and the last stage of the series association of stages of the battery.

According to an embodiment, the management system further comprises a balancing circuit comprising, for each first voltage sensor, a first balancing unit comprising first and second nodes of connection to the battery respectively connected to the first and second measurement nodes of the voltage sensor.

According to an embodiment, each balancing unit comprises a transistor in series with a resistor between its first and second node of connection to the battery.

According to an embodiment, each balancing unit comprises a DC/DC converter.

The foregoing and other features and advantages will be discussed in detail in the following non-limiting description of specific embodiments in connection with the accompanying drawings.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is an electric diagram of an example of an assembly comprising an electric battery and an electronic battery management system;

FIG. 2 is an electric diagram of an embodiment of an assembly comprising an electric battery and an electronic battery management system;

FIG. 3 schematically shows an example of layout of the elements of an assembly of the type described in relation with FIG. 2;

FIG. 4 is a logic diagram illustrating an example of an electric battery management method in an assembly of the type described in relation with FIG. 2; and

FIG. 5 is a logic diagram illustrating in further detail an example of a method of balancing the cells of a battery in an assembly of the type described in relation with FIG. 2.

### DETAILED DESCRIPTION OF THE PRESENT EMBODIMENTS

The same elements have been designated with the same reference numerals in the different drawings. In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, “lateral”, etc., it is referred to the orientation of the corresponding drawings, it being understood that, in practice, the described devices may be arranged differently. Unless otherwise specified, expressions “approximately”, “substantially”, and “in the order of” mean to within 10%, preferably to within 5%. In the present description, term “connected” is used to designate a direct electric connection, with no intermediate electronic component, for example, by means of one or a plurality of conductive tracks and/or of a normally-on fuse-type protection element, and term “coupled” or term “linked” is used to designate either a direct electric connection (then meaning “connected”) or a connection via one or a plurality of intermediate components (resistor, diode, capacitor, etc.).

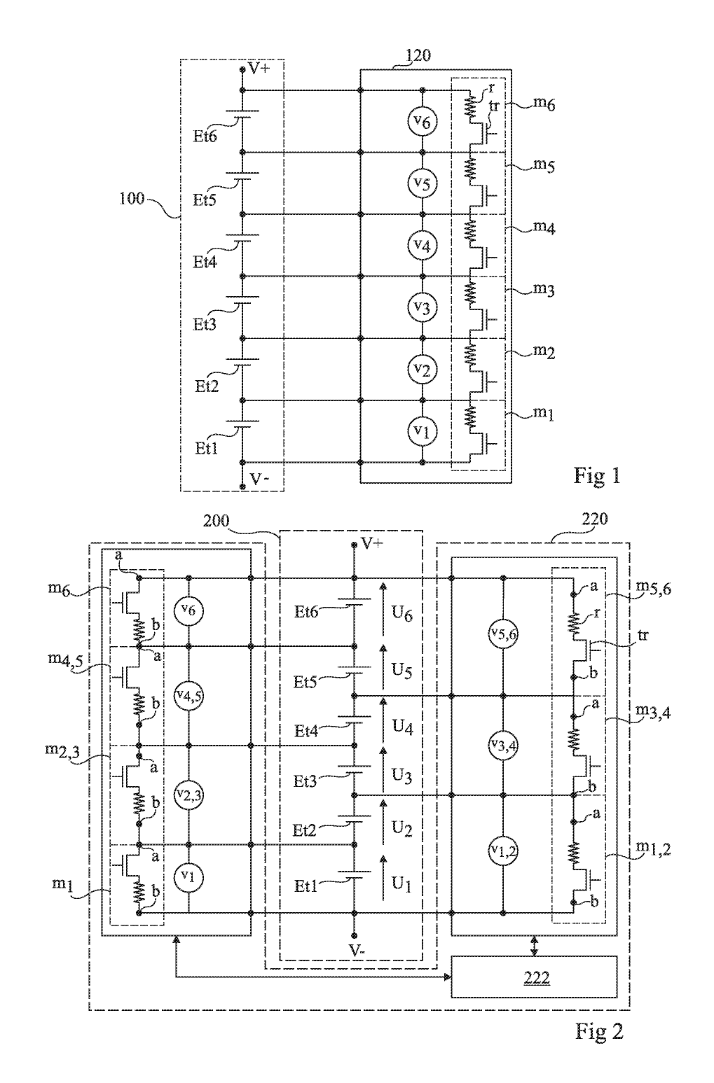

FIG. 1 shows an example of an assembly comprising a battery 100 and an electronic battery management system 120.

In the shown example, battery 100 comprises six stages Et1, Et2, Et3, Et4, Et5, and Et6 series-connected between a negative terminal V− and a positive terminal V+ of the battery. Each stage Et1 may be formed of a single electrical energy storage cell, or of a plurality of cells connected in series and/or in parallel between a negative terminal and a positive terminal of the stage.

Electronic system 120 for managing battery 100 comprises one voltage measurement circuit (or voltage sensor) vᵢ per stage Eti of the battery, i being an integer in the range from 1 to N, and N being an integer designating the number of battery stages (N=6 in the shown example). Each voltage sensor vᵢ is capable of measuring the voltage across the stage Eti associated therewith. To achieve this, each voltage sensor vᵢ has a first low potential measurement node or negative measurement node coupled to the negative terminal of stage Eti, and has a second high potential measurement node or positive measurement node coupled to the positive terminal of stage Eti.

Management system 120 may be configured to control the operations of recharge and discharge of battery 100 by taking into account the voltage values of the different stages Eti measured by sensors vᵢ. As an example, management system 120 may be configured to, during recharge phases, monitor the stage-of-charge of the stages and interrupt the recharge sufficiently soon to avoid for the stages to exceed a critical discharge level beyond which they might be damaged and, during discharge phases, monitor the state-of-charge of the stages and interrupt the discharge sufficiently soon to avoid for the stages to pass a critical discharge level below which they might be damaged.

Management system 120 may further be capable of balancing the charge levels of the different battery stages by taking into account the voltage values of the different stages measured by sensors vᵢ. For this purpose, in the shown example, management system 120 comprises a balancing circuit comprising one balancing unit mᵢ per battery stage Eti. Each balancing unit mᵢ comprises a transistor tr in series with a resistor r between the negative terminal and the positive terminal of stage Eti. Each unit mᵢ may be individually controlled, via its transistor tr, by a control circuit not shown, to partially discharge, by dissipation in resistor r, the stage Eti connected thereto.

Management system 120 may further be configured to detect, by taking into account the voltage values of the different stages supplied by sensors vᵢ, possible defects of certain battery stages, for example, a shorting or an opening of the circuit of a cell of the battery stage, and accordingly take safety measures such as interrupting the battery recharge or discharge current.

The configuration of FIG. 1 has various disadvantages. In particular, the configuration of FIG. 1 does not enable, as is, to detect a possible malfunction of a voltage sensor vᵢ of management system 120. If a voltage sensor vᵢ of management system 120 supplies an abnormal value, management system 120 will assume, by precaution, that stage Etᵢ is defective, and battery safety measures, which may be constraining for the user, will be implemented. However, in certain cases, when a sensor vᵢ of management system 120 outputs an abnormal value, the failure may actually be at the level of the sensor itself, rather than at the battery level. It would thus be desirable to be able to tell a failure of the battery management system from an effective battery failure, to be able to avoid a constraining procedure for placing the battery in safe conditions when such a procedure is not absolutely necessary. As an example, in case of a failure of a sensor of the management system, it would be sufficient to notify the failure to the user, to allow him/her to have the management system repaired at his/her convenience, without for all this interrupting the battery operation.

A solution to enable to tell a failure of the sensor of the battery management system from an effective failure of the battery is to duplicate all the voltage sensors of the management system, that is, to provide two different voltage sensors per stage Eti of the battery, both measuring the voltage across stage Eti. In case of an inconsistency between the measurements output by the two sensors, it can be deduced that one of the sensors is defective. Such a solution however has a significant extra cost.

Another disadvantage of the configuration of FIG. 1 is that each voltage sensor vᵢ should be connected to the two terminals of stage Eti associated therewith, while said terminals may be relatively distant from each other. As a result, the length of conductive wire or of conductive track necessary to connect management system 120 to battery 100 is relatively high.

FIG. 2 shows an example of an embodiment of an assembly comprising a battery 200 and an electronic system 220 for managing battery 200.

In the shown example, battery 200 is identical or similar to battery 100 of the assembly of FIG. 1. In particular, battery 200 comprises six stages Et1, Et2, Et3, Et4, Et5, and Et6 series-connected between a negative terminal V− and a positive terminal V+ of the battery. Each stage Eti may be formed of a single electrical energy storage cell, or of a plurality of cells connected in series and/or in parallel between a negative terminal and a positive terminal of the stage. As an example, stages Eti of battery 200 all have the same full-charge nominal voltage, and the same nominal charge storage capacity. The different stages Eti of battery 200 are for example identical to within manufacturing dispersions. The described embodiments are however not limited to these specific cases. Further, the described embodiments may apply to batteries comprising a number N of stages coupled in series different from 6. More generally, the described embodiments apply whatever the number N of series-connected stages Eti greater than or equal to 3. It is here considered, as shown in FIG. 2, that stages Et1 to EtN are series-connected by order of increasing index, stage Et1 having its negative terminal connected to negative terminal V− of the battery, and stage EtN having its positive terminal connected to positive terminal V+ of the battery.

Electronic system 220 for managing battery 200 comprises N-1 (that is, 5 in the shown example) voltage measurement circuits or voltage sensors v_{j,j+1}, j being an integer in the range from 1 to N-1. Each voltage sensor v_{j,j+1} is capable of measuring the voltage across the series association of the two adjacent stages Etj and Etj+1. To achieve this, each voltage sensor v_{j,j+1} has a first low potential measurement node or negative measurement node connected to the negative terminal of stage Etj, and a second high potential measurement node or positive measurement node coupled to the positive terminal of stage Etj+1. Thus, each stage Eti of the battery has its positive terminal coupled to one of voltage sensors v_{j,j+1}, while its negative terminal is not coupled to this same sensor. Similarly, each battery stage Eti has its negative terminal coupled to one of voltage sensors v_{j,j+i}, while its positive terminal is not coupled to this same sensor.

Electronic system 220 for controlling battery 200 further comprises at least one voltage sensor vᵢ capable of measuring the voltage across a single battery stage Eti, that is, having its low potential and high potential measurement nodes respectively coupled to the negative terminal and to the positive terminal of a same stage Eti. In the shown example, management system 220 comprises two voltage sensors v₁ and v_{N} respectively connected across stage Et1 and across stage EtN. As a variation, one of the two voltage sensors v₁ and v_{N} may be omitted. As a variation, it is possible for the management system to comprise neither sensor v₁ nor sensor v_{N}, but to comprise a voltage sensor vᵢ connected across a stage Eti having an intermediate rank between 1 and N. As an example, management system 220 comprises no more than two voltage sensors vᵢ connected across single stages Eti (including when N is greater than 3).

Management system 220 further comprises a processing and control circuit 222 capable of receiving the values of the voltages measured by sensors v_{j,j}±ᵢ and by sensor(s) vᵢ, and of deducing therefrom, by subtraction operations, the values of the voltages across each of the battery stages. Circuit 222 for example comprises a digital calculation unit, for example, a microprocessor, receiving in digital form the voltage values measured by the voltage sensors. To achieve this, each voltage sensor may comprise an analog-to-digital converter or be coupled to the digital calculation unit via an analog-to-digital converter.

In the shown example, voltage U₁ across stage Et1 may be supplied by sensor v₁. Knowing voltage U₁, voltage U₂ across stage Et2 can be determined by subtracting voltage U₁ to the voltage supplied by sensor v_{1,2}. Knowing voltage U₂, voltage U₃ across stage Et3 can be determined by subtracting voltage U₂ to the voltage supplied by sensor v_{2,3}. Knowing voltage U₃, voltage U₄ across stage Et3 can be determined by subtracting voltage U₃ to the voltage supplied by sensor v_{3,4}. Knowing voltage U₄, voltage U₅ across stage Et5 can be determined by subtracting voltage U₄ to the voltage supplied by sensor v_{4,5}. Finally, knowing voltage U₅, voltage U₆ across stage Et6 can be determined by subtracting voltage U₅ to the voltage supplied by sensor v_{5,6}.

More generally, whatever its position in the battery, a single voltage sensor vᵢ connected across a single battery stage Eti is sufficient to be able to trace back the individual voltages Uᵢ of each of the battery stages from the voltage values measured by sensors v_{i,j+1}.

An advantage of the configuration of FIG. 2 is that it enables, to a certain extent, to detect defects of the voltage sensors of the management system. For example, if sensor v₁ supplies an abnormally high voltage value, for example, greater than twice the full charge nominal voltage of a stage, while sensor v_{1,2} supplies a voltage smaller than this value, it can be deduced that at least one of sensors v₁ and v_{1,2} is defective. More generally, having determined voltage Uⱼ across a stage Etj of the battery, if the value of the voltage supplied by sensor v_{j,j+1} or by sensor v_{j-1, j} is smaller than voltage Uⱼ, it can be deduced that at least one voltage sensor of the management system is defective.

In the shown example, the provision of two voltage sensors v₁ and v_{N} respectively connected across end stages Et1 and EtN of the battery, enables to introduce an additional redundancy level (as compared with a configuration comprising a voltage sensor vᵢ connected across a single stage Eti of the battery), and to further increase the possibilities of detection of a failure of the voltage sensors of the management system. In particular, in the example of FIG. 6, circuit 222 may check the consistency of the measurements supplied by the different voltage sensors by comparing the sum of the voltage values measured by sensors v_{1,2}, v_{3,4} and v_{5,6} with the sum of the voltage values measured by sensors v₁, v_{2,3}, v_{4,5} and v₆. If the two sums are not identical (to within measurement inaccuracies), it can be deduced that at least one of the voltage sensors is defective. Further, circuit 222 may check the consistency between the value of voltage U₆ estimated by subtraction of voltage U₅ to the measurement supplied by sensor v_{5,6}, and the value of voltage U₆ measured by sensor v₆.

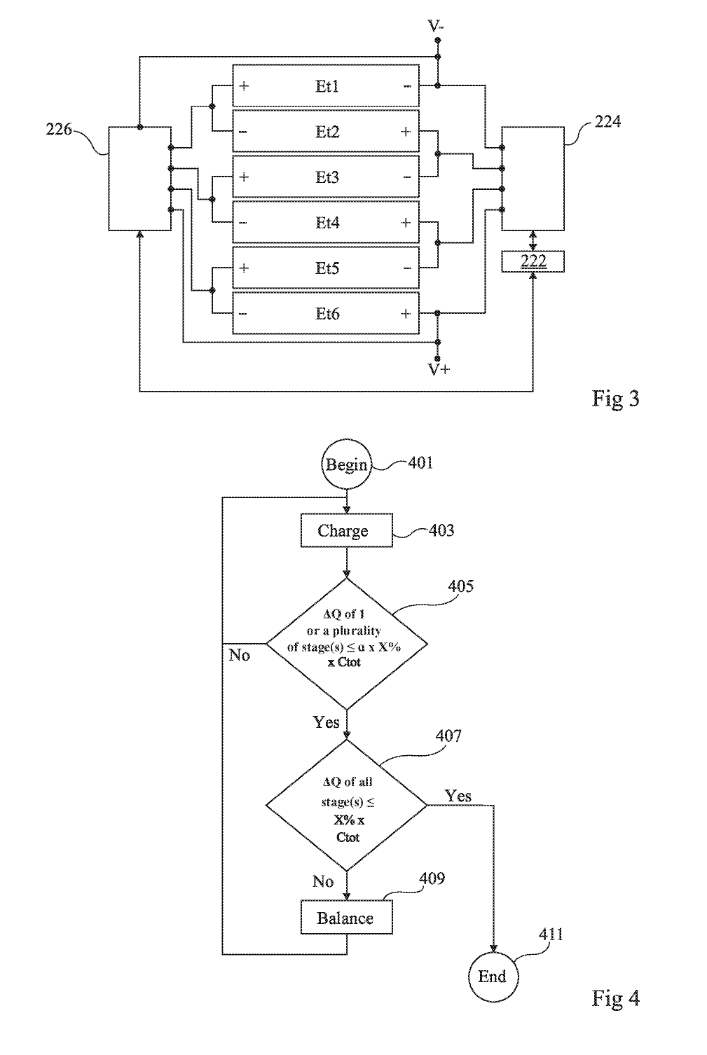

Another advantage of the configuration of FIG. 2 is that the measurement nodes of a same voltage sensor v_{j,j+1} are not connected to the two terminals of a same battery stage, but are respectively connected to the negative terminal of a first stage Etj and to the positive terminal of a second stage Etj+1 adjacent to the first stage, which terminals are generally close to each other, as illustrated in FIG. 3 described hereafter. This results in a decrease in the total conductive wire or conductive track length necessary to connect the management system to the battery with respect to a configuration of the type described in relation with FIG. 1.

FIG. 3 schematically shows an example of layout of the elements of an assembly of the type described in relation with FIG. 2. In this example, each stage Eti of the battery is formed of a single accumulator having a generally cylindrical shape, having its negative and positive connection terminals respectively arranged on the two ends of the cylinder, that is, on the two opposite parallel surfaces of the cylinder orthogonal to the longitudinal axis thereof. Accumulators Et1, Et2, Et3, Et4, Et5, Et6 are aligned so that their respective longitudinal axes are substantially horizontal, and that their respective ends are arranged in two substantially vertical planes. Accumulators Et1, Et2, Et3, Et4, Et5, Et6 are alternatively arranged head to tail, that is, so that each accumulator Etj has its positive terminal in the same vertical plane as the negative terminal of accumulator Etj+1, and has its negative terminal in the same vertical plane as the positive terminal of accumulator Etj+1.

Thus, in the example of FIG. 3, each voltage sensor v_{j,j+1} has its negative and positive measurement nodes connected to terminals located on a same side of the accumulator assembly, which enables to limit the length of the connection tracks or wires. More particularly, in this example, sensors v_{1,2}, v_{3,4} and v_{5,6} (FIG. 2) are arranged on the right-hand side of the accumulator assembly, and sensors v_{2,3} and v_{4,5} (FIG. 2) are arranged on the left-hand side of the accumulator assembly. In this example, only sensors v₁ and v₆ (FIG. 2) have their measurement nodes connected on either side of the accumulator assembly. As an example, sensors v_{1,2}, v_{3,4} and v_{5,6} may be integrated in a same integrated circuit chip 224 arranged on the right-hand side of the accumulator assembly, and sensors v₁, v_{2,3}, v_{4,5} and v₆ may be integrated in a same integrated circuit chip 226 different from chip 224, arranged on the left-hand side of the accumulator assembly. Processing and control circuit 222 may be integrated to one of chips 224 and 226, or be formed in a different chip.

Management system 220 of the assembly of FIG. 2 may be made capable of performing various operations by taking into account the values of voltages Uᵢ of stages Eti determined by processing and control circuit 222. In particular, management system 220 may be configured to control, by taking into account the values of voltages Uᵢ, the phases of recharge and discharge of battery 200, and interrupt the recharge or the discharge sufficiently soon to avoid for the stages to exceed a critical charge level or a critical discharge level. Further, management system 220 may be capable of detecting, by taking into account voltages Uᵢ, possible defects of certain battery cells, and accordingly take safety measurements such as cutting off the battery recharge or discharge current. Further, management system 220 may be capable of balancing the charge levels of the different stages Eti of the battery by taking into account the values of voltages Uᵢ.

Balancing

Examples of balancing circuits and methods adapted to a configuration of the type described in relation with FIG. 2 will now be described.

In a first embodiment (not shown), management system 220 comprises a balancing circuit identical or similar to that of management system 120 of FIG. 1, that is, comprising one balancing unit mᵢ per battery stage Eti, each balancing unit mᵢ being individually controllable by a control circuit, for example, circuit 222, by taking into account the values of voltage Uᵢ of the different stages determined from the measurements supplied by the voltage sensors.

This solution has the advantage of being simple to implement, and compatible with methods of balancing of assemblies of the type described in relation with FIG. 1. However, a disadvantage of this solution is that it implies providing additional connections between management system 220 and the battery.

In another embodiment illustrated in FIG. 2, the balancing circuit of management system 220 comprises one balancing unit per voltage sensor, connected to the same battery nodes as the corresponding voltage sensor. Thus, the balancing circuit of management system 220 comprises N-1 balancing units m_{j,j+1}, each unit m_{j,j+1} being connected across the series association of the adjacent stages Etj and Etj+1. In the shown example, the balancing circuit of management system 220 further comprises two balancing units m₁ and m_{N}, respectively connected across stage Et1 and across stage EtN. In this example, the balancing units are dissipative units, individually controllable to discharge the battery stage(s) across which they are connected. More particularly, in this example, each balancing unit comprises two nodes a and b of connection of the balancing unit to the battery (for example, confounded with the measurement nodes of the corresponding voltage sensor), and, between its nodes a and b, a series association of a resistor r and of a control transistor tr.

An advantage of the balancing circuit of FIG. 2 is that it requires no connections between management system 220 and the battery other than the connections required to connect the voltage sensors to the battery.

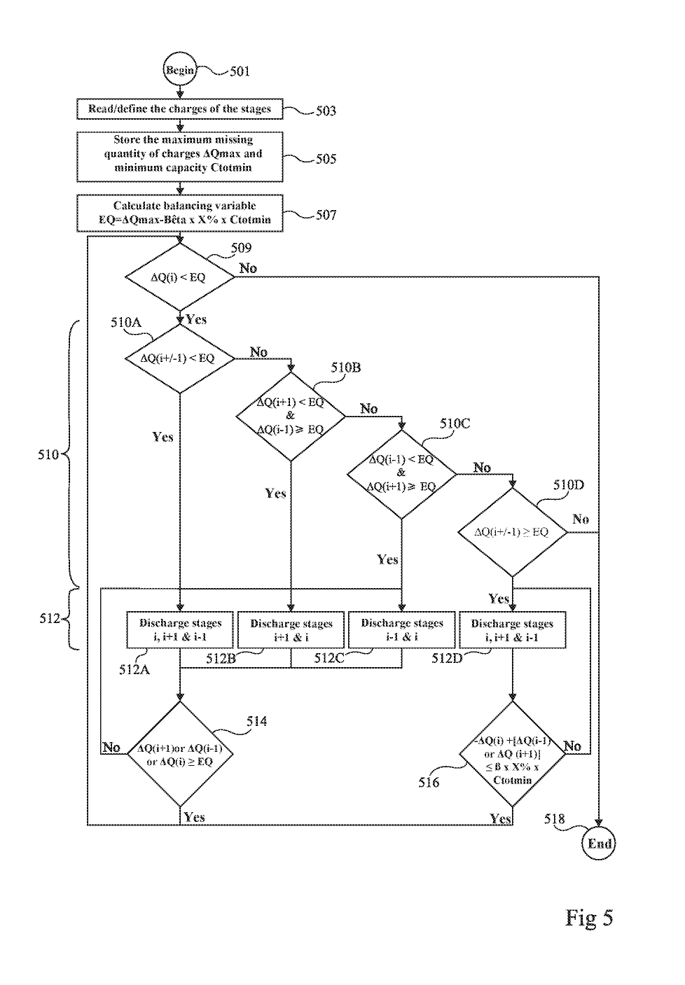

An example of a method of controlling a balancing circuit of the type shown in FIG. 2 will now be described in relation with FIGS. 4 and 5. In this example, it will be considered that management system 220 of the battery may know at any time the quantity of charges contained in each stage Eti of the battery, as well as the total charge storage capacity of each stage Eti of the battery (it being understood that the total charge storage capacity of a stage is likely to vary as the battery ages). To achieve this, battery management system 220 may comprise, in addition to the above-described voltage sensors, current sensors, and/or charge counters, not shown. The control method described hereafter may however be adapted to a simplified control mode where the quantities of charges contained in the different stages Eti are approximated by voltages Uᵢ across stages Eti, and where the total storage capacities of the different stages Eti are considered as being constant along time and are approximated by the nominal full charge voltages of stages Eti.

FIG. 4 shows in the form of blocks an example of a method of recharging battery 200 including a balancing of stages Eti at the end of charge, implemented by battery management system 220 in an assembly of the type described in relation with FIG. 2.

Block 401 (“Begin”) of FIG. 4 represents the beginning of the recharge phase.

During a step 403 (“Charge”), management system 220 controls the application of a recharge current in the battery.

At a step 405 (“ΔQ of 1 or a plurality of stage(s)≦α*X%*Ctot”), in parallel with battery recharge step 403, management system 220 verifies, for example continuously or periodically, whether, in at least one battery stage Eti, the quantity of charges ΔQ missing to reach the full charge of the stage is smaller than or equal to α*X%*Ctot, where Ctot designates the total charge storage capacity of stage Eti, where X is a percentage, for example, in the range from 1 to 5%, defining the targeted balancing accuracy, and where a is a parameterizing coefficient smaller than or equal to 1, for example, in the order of 0.1, enabling, when it is smaller than 1, to obtain a faster convergence of the balancing. It is here considered that the battery is charged and balanced when, in each of stages Eti of the battery, the quantity of missing charges ΔQ in the stage is smaller than X%*Ctot, where Ctot designates the total charge storage capacity of stage Eti.

If none of stages Eti of the battery fulfills the condition verified at step 405 (“No”), battery recharge step 403 carries on.

If at least one stage Eti of the battery fulfills the condition verified at step 405 (“Yes”), step 403 is interrupted, that is, the battery recharge current is cut off.

Management system 220 then verifies, at a step 407 (“ΔQ of all stages <X%*Ctot”), whether, in each stage Eti of the battery, the quantity of charges ΔQ missing to reach the full charge of the stage is smaller than or equal to X% of the total charge storage capacity of the stage.

If the condition verified at step 407 is not fulfilled (“No”), a balancing of the battery is implemented at a step 409 (“Balance”). The balancing method implemented at step 409 will be described in further detail hereafter in relation with FIG. 5. At the end of balancing step 409, the recharge method resumes from step 403, that is, the battery recharge current is applied again.

If the condition verified at step 407 is fulfilled (“Yes”), this means that all stages Eti of the battery are charged and balanced, and the recharge method ends.

Block 411 (“End”) of FIG. 4 represents the end of the recharge phase.

FIG. 5 shows in the form of blocks an embodiment of balancing step 409 of the recharge method of FIG. 4.

Stages Eti of the battery conducting a same recharge current, it is desired, at balancing step 409, to take substantially to a same value the missing quantities of charges ΔQ in the different stages Eti, to maximize chances of reaching the balancing at the next iteration of steps 403 to 407.

Block 501 (“Begin”) of FIG. 5 represents the beginning of balancing phase 409.

At a step 503 (“Read/define the charges of the stages”), the quantities of charges contained in the different stages Eti are determined.

At a next step 505 (“Store the maximum missing quantity of charges ΔQmax and minimum capacity Ctotmin”), the management system determines and stores the missing quantity of charges ΔQmax in the stage Eti most distant from its full charge level, and the total charge storage capacity Ctotmin of the stage Eti having the smallest charge storage capacity.

At a next step 507 (“Calculate balancing variable EQ=ΔQmax-β*X%*Ctotmin”), the balancing system calculates the value of a balancing variable EQ=ΔQmax-β*X%*Ctotmin, where β is a parameterizing coefficient smaller than 1 (possibly zero), for example, in the order of 0.5. Balancing variable EQ corresponds, as a first approximation, to the quantity of charges to be removed from the most charged stage of the battery during balancing phase 409. Term β*X%*Ctotmin (when coefficient β is not zero) enables to accelerate the convergence of the balancing by taking into account the fact that the stage having the smallest charge storage capacity has chances of reaching its full charge level faster than the others, and by taking into account the end-of-balancing condition (ΔQ≦X%*Ctot in all stages).

For each stage Eti of the battery, the management system then determines, at a step 509 (“ΔQ(i)<EQ”), whether the quantity of missing charges ΔQ(i) in stage Eti is smaller than balancing variable EQ.

If it is not (“No”), stage Eti is not directly concerned by the balancing.

If it is (“Yes”), stage Eti is directly concerned by the balancing. The management system then determines which of the four following configurations 510A, 510B, 510C and 510D corresponds to the battery state:

510A (“ΔQ(i+/−1)<EQ”): the quantities of missing charges ΔQ(i−1) and ΔQ(i+1) of stages Eti−1 and Eti+1 are both smaller than balancing variable EQ;

510B (“ΔQ(i+1)<EQ & ΔQ(i−1)≧EQ”): the quantity of missing charges ΔQ(i+1) of stage Eti+1 is smaller than balancing variable EQ, and the quantity of missing charges ΔQ(i−1) of stage Eti−1 is greater than or equal to balancing variable EQ;

510C (“ΔQ(i−1)<EQ & ΔQ(i+1)≧EQ”): the quantity of missing charges ΔQ(i−1) of stage Eti−1 is smaller than balancing variable EQ, and the quantity of missing charges ΔQ(i+1) of stage Eti+1 is greater than or equal to balancing variable EQ; and

510D (“ΔQ(i+/−1)>EQ”): the quantities of missing charges ΔQ(i−1) and ΔQ(i+1) of stages Eti−1 and Eti+1 are both greater than or equal to balancing variable EQ.

At a step 512 following step 510, the actual balancing of stage Eti or of the neighboring stage(s) Eti−1 and Eti+1 is performed. It should be noted that for stages Eti of rank i=1 or i=N, stages Eti−1, respectively Eti+1, do not exist and are neither considered nor balanced.

If the battery is in configuration 510A, management system 220 controls, at a step 512A (“Discharge stages i, i+1 & i−1”), the discharge of stages Eti and Eti+1, and Eti−1. The discharge of stages Eti and Eti+1 may be carried out by balancing unit m_{i,i+1}, and the discharge of stages Eti and Eti−1 may be carried out by balancing unit m_{i-1,i}.

If the battery is in configuration 510B, management system 220 controls, at a step 512B (“Discharge stages i+1 & i”), the discharge of stages Eti+1, and Eti. The discharge of stages Eti+1 and Eti may be performed by balancing unit m_{i,i+1}.

If the battery is in configuration 510C, management system 220 controls, at a step 512C (“Discharge stages i−1 & i”), the discharge of stages Eti−1, and Eti. The discharge of stages Eti−1 and Eti may be carried out by balancing unit

If the battery is in configuration 510D, management system 220 controls, at a step 512D (“Discharge stages i, i+1 & i−1”), the discharge of stages Eti, Eti−1, and Eti+1. The discharge of stages Eti and Eti+1 may be carried out by balancing unit m_{i,i+i}, and the discharge of stages Eti and Eti−1 may be carried out by balancing unit

After step 512A, 512B or 512C, management system 220 determines, at a step 514 (“ΔQ(i+1) or ΔQ(i−1) or ΔQ(i)≧EQ”), whether the quantity of missing charges ΔQ in one of the stages being discharged has reached balancing variable EQ. If it has not (“No”), the initiated discharge step 512A, 512B, or 512C carries on. If the quantity of missing charges ΔQ in one of the stages being discharged has reached balancing value EQ (“Yes”), the balancing method starts again from step 509.

After step 512D, management system 220 determines, at a step 516 (“−ΔQ(i)+[ΔQ(i−1) or ΔQ(i+1)]≦β*X%*Ctotmin”), whether the difference between the quantity of missing charges ΔQ(i−1) in stage Eti−1 and the quantity of missing charges ΔQ(i) in stage Eti, or the difference between the quantity of missing charges ΔQ(i+1) in stage Eti+1 and the quantity of missing charges ΔQ(i) in stage Eti, is smaller than term β*X%*Ctotmin. If it is (“Yes”), the balancing method starts again from step 509. If it is not (“No”), step 512D of discharge of stages Eti, Eti+1, and Eti−1 carries on.

At step 509, if none of stages Eti of the battery is concerned by the balancing, that is, if the quantity of missing charges in each of stages Eti is greater than or equal to balancing variable EQ, the balancing phase ends.

Block 518 (“End”) of FIG. 5 represents the end of the balancing phase.

Specific embodiments have been described. Various alterations, modifications, and improvements will occur to those skilled in the art. In particular, the described embodiments are not limited to the examples of balancing methods and circuits described in relation with FIGS. 2, 4, and 5. The described embodiments may in particular be capable of implementing a so-called active balancing, that is, where not only the excess energy in the most charged stages is dissipated, but also energy transfers between the most charged stages and the least charged stages are carried out. As an example, the dissipative balancing units m_{j,j+1} of the balancing circuit of FIG. 2 may be replaced with active balancing units. Each active balancing unit for example comprises a DC/DC converter connected between nodes a and b of the unit. As an example, each active balancing unit comprises a transformer comprising a first conductive winding between nodes a and b of the unit and a second secondary conductive winding magnetically coupled to the first winding, between terminals V− and V+ of the battery. An advantage of such a configuration is that the DC/DC converters then see higher voltages than in a configuration where each balancing unit is connected across a single stage of the battery. This results in a better conversion efficiency during the balancing.

Further, the described embodiments are not limited to the specific example described in relation with FIG. 2 where the voltage sensors of the management system have their measurement nodes coupled by two adjacent stages of the battery. As a variation, it may be provided to interlace voltage sensors of the management system so that each sensor measures the voltage across a series association of three adjacent battery stages, or of a number of adjacent stages greater than three.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. An assembly comprising a battery of electrical energy storage cells and a management system, wherein:
the battery comprises at least three stages (Eti) in series between a negative terminal (V−) and a positive terminal (V+) of the battery, each stage (Eti) comprising a single cell or a plurality of cells in series and/or in parallel between a negative terminal and a positive terminal of the stage; and
the management system comprises:
at least two first voltage sensors (v_{j,j+1}), each first sensor having first and second measurement nodes connected by at least two consecutive stages (Etj, Etj+1) of the battery and being capable of measuring the voltage across the series association of said at least two consecutive stages (Etj, Etj+1), said first sensors (v_{j,j+1}) being arranged so that each stage (Eti) has its positive terminal connected to one of the first sensors (v_{j,j+1}), and does not have its negative terminal connected to the same first sensor (v_{j,j+1}); and
at least one second voltage sensor (vᵢ) having first and second measurement nodes respectively connected to the positive terminal and to the negative terminal of a same stage (Eti) of the battery and being capable of measuring the voltage across this stage.

2. The assembly of claim 1, wherein the management system further comprises a processing circuit configured to receive the values of the voltages measured by said voltage sensors (v_{j,j+i}, vᵢ), and of deducing therefrom, by subtraction operations, the value of the voltage (Uᵢ) across each of the stages (Eti).

3. The assembly of claim 1, wherein each of the first sensors (v_{j,j+i}) has its measurement nodes coupled by only two consecutive stages (Etj, Etj+1) of the battery.

4. The assembly of claim 1, comprising a single second voltage sensor (v1).

5. The assembly of claim 4, wherein said second voltage sensor (v₁) is connected across a stage (Et1) located at one end of the series association of stages (Eti) of the battery.

6. The assembly of claim 1, only comprising two second voltage sensors (v₁, v_{N}).

7. The assembly of claim 6, wherein said second voltage sensors (v₁, v_{N}) are respectively connected across the first stage (Et1) and the last stage (EtN) of the series association of stages (Eti) of the battery.

8. The assembly of claim 1, wherein the management system further comprises a balancing circuit comprising, for each first voltage sensor (v_{j,j+j}), a first balancing unit (m_{j,j+i}) comprising first (a) and second (b) nodes of connection to the battery respectively connected to the first and second measurement nodes of the voltage sensor (v_{j,j+1}).

9. The assembly of claim 8, wherein each balancing unit (m_{j,j+1}) comprises a transistor (tr) in series with a resistor (r) between its first (a) and second (b) node of connection to the battery.

10. The assembly of claim 8, wherein each balancing unit (m_{j,j+1}) comprises a DC/DC converter.
